(19) United States
(12) Patent Application Publication
(10) Pub. No.: US 2006/0267327 A1
(43) Pub. Date: Nov. 30, 2006

(54) APPARATUS FOR ATTACHMENT OF A CAMERA TO A VEHICLE

(75) Inventor: OLAF JABLONSKI, Grevenbroich (DE)

Correspondence Address: HENRY M FEIEREISEN, LLC, 350 FIFTH AVENUE, SUITE 4714, NEW YORK, NY, 10118, US

(73) Assignee: move'n shoot GmbH, Dusseldorf (DE)

(21) Appl. No.: 11/420,898

(22) Filed: May 30, 2006

Related U.S. Application Data
(60) Provisional application No. 60/718,468, filed on Sep. 19, 2005.

(30) Foreign Application Priority Data
May 30, 2005 (DE) 10 2005 025 024.6

(51) Int. Cl. B60S 9/02

(52) U.S. Cl. 280/766.1

(57) ABSTRACT

An apparatus for attachment of a camera to a vehicle includes an outrigger and a mounting device for securing the outrigger to the vehicle. Disposed at a desired position of the outrigger is a mounting element for fastening a camera. In order to realize a controlled pivoting of the outrigger, a swivel mechanism is incorporated, for example, in an area of the mounting device.

### CROSS-REFERENCES TO RELATED APPLICATIONS

This application claims the benefit of prior filed U.S. provisional Application No. 60/718,468, filed Sep. 19, 2005, pursuant to 35 U.S.C. 119(e), the content of which is incorporated herein by reference.

This application also claims the priority of German Patent Application, Serial No. 10 2005 025 024.6, filed May 30, 2005, pursuant to 35 U.S.C. 119(a)-(d).

### BACKGROUND OF THE INVENTION

The present invention relates to an apparatus for attachment of a camera to a vehicle, with the camera disposed at a defined position to the vehicle by means of an outrigger secured to the vehicle.

Nothing in the following discussion of the state of the art is to be construed as an admission of prior art.

An apparatus of this type is generally called camera rig and has a mounting device for securing an outrigger of the camera rig to the underbody of a vehicle such as a passenger car, truck, motorcycle, bicycle etc. In order to enable shots of a target from various viewpoints, the camera rig has a joint which is located between the outrigger and the mounting device and can be fixed in place at a desired position within a pivot range, when the camera rig is installed. During travel, the position of the outrigger is fixed in relation to the vehicle in order to ensure a shot from the desired angle which has been set beforehand.

Construction of such a camera rig must meet many demands. The camera including its high own weight of up to 50 kg—in particular when a film camera is involved—is mounted to the outrigger of up to 4.5 m. All forces and moments resultant from the weight force of the camera as well as of the outrigger are transmitted from the mounting device into the points of articulation of the vehicle. Thus, particular attention is given to lightweight construction of such a camera rig. At the same time, it must be ensured that the camera consistently retains its defined position in relation to the vehicle during travel of the automobile. An outrigger swinging within the rig as a result of elasticity or play would make it impossible to render sharp moving images or still images.

It would therefore be desirable and advantageous to provide an improved camera rig system to obviate prior art shortcomings and to provide more versatility.

### SUMMARY OF THE INVENTION

According to one aspect of the present invention, an apparatus for attachment of a camera to a vehicle includes an outrigger, a mounting device for securing the outrigger to the vehicle, a mounting element disposed at the outrigger for fastening a camera, and a swivel mechanism for controlled pivoting of the outrigger, that preferably is incorporated in an area of the mounting device. The mounting element may hereby be disposed at a vehicle-distal area of the outrigger, or any other suitable location of the outrigger. The swivel mechanism may be incorporated in an area of the mounting device, or any other suitable location.

The present invention resolves prior art problems by providing the camera rig with a swivel mechanism for controlled pivoting of the outrigger. In this way, it is possible to change the camera viewpoint in relation to the vehicle during travel of the vehicle. Suitably, the apparatus is connected to the vehicle in an area of the chassis of the vehicle. Disposition in the area of the chassis of the vehicle eliminates a shooting of shades or reflections that the apparatus according to the invention casts on surfaces of the vehicle or environment. For realizing an attachment in the area of the chassis of the vehicle, the mounting device is suitably constructed such as to extend substantially horizontal.

The swivel mechanism may include various assemblies which optionally may be locally separated, with each assembly being able to pivot the outrigger about at least one axis. To allow the desired change in camera view point in relation to the vehicle during travel of the vehicle, the outrigger is connected to the mounting device in a pivotable manner. This pivotable manner can be achieved, if according to another feature of the present invention, the swivel mechanism has a joint, disposed between the mounting device and the outrigger, for allowing a rotation of the outrigger about a vertical axis of the joint, wherein the mounting device and the joint preferably define together a height of maximal 300 mm, suitably maximal 270 mm. Preferably, the outrigger is connected on one of its ends with the joint.

In order to realize a greatest possible pivot range, the swivel mechanism may be constructed to pivot the outrigger about at least two axes. Suitably, these two axes extend perpendicular to one another. To still further enhance, for example, the versatility of possible camera movements, the swivel mechanism can be constructed such as to allow the outrigger to pivot about more than two axes.

The swivel mechanism is suitably arranged in the area of the mounting device for securing the apparatus to the vehicle so that the outrigger constructed with little own weight (accelerated mass during pivoting) is not subjected to loads from other foreign weights. It may therefore constitute a component of the mounting device. It may also be possible to dispose the swivel mechanism in the joint between the outrigger and the mounting device, or even in the outrigger itself.

Any construction of the swivel mechanism is possible. For example, electric servomotors can be used. This especially allows a main part of the swivel mechanism to be integrated in a joint that connects the outrigger to the mounting device. It is also possible to use a rotating electric motor which transmits the driving power to the outrigger via cables or chains for example, pulling or pushing the outrigger to swivel around a joint that connects the outrigger to the mounting device. In this case, it is even possible to arrange the drive motor virtually at any location in or on the vehicle and to realize a pivoting of the outrigger via a respective deflection of the articulated cables.

According to another feature of the present invention, the swivel mechanism may include a lifting unit for pivoting the outrigger about a substantially horizontal axis. The lifting unit may be arranged directly inside the apparatus, or the driving power may be transmitted to the apparatus via cables or chains.

According to another feature of the present invention, the mounting element for receiving the camera may be movably connected to the outrigger in at least one direction. Suitably, the mobile mounting element allows a translatory motion between the mounting element and the longitudinal beam in length direction of the longitudinal beam. The mounting element may be arranged hereby on or in the outrigger. As a consequence of the mobility of the mounting element in relation to the outrigger, the distance between the camera and the target, i.e. the vehicle, can be randomly adjusted. The outrigger may be constructed in the form of a telescopic arm.

To enable this also during operation of the vehicle, a drive may be provided which allows a controlled movement of the mounting element on or in the outrigger. The drive may be arranged in or on the mounting element or the outrigger. It may directly transmit the driving power or via any number of intermediate elements. For example, the drive for the mounting element may also be arranged in the area of the mounting device or at any location in or on the vehicle and transmit the driving power onto the movable mounting element via cables or chains or threaded spindles for example.

According to another feature of the present invention, a control unit may be provided for controlling operation of the swivel mechanism and/or the drive of the mounting element. The control unit may include a controller which is suitably programmable so that a movement of the outrigger and/or the mounting element during operation of the vehicle can be realized in accordance with a defined movement plan. This has, i.a., the advantage that the movement of the outrigger during shooting and thus the still or moving sequences are completely reproducible.

To ensure clarity, it is necessary to establish the definition of several important terms and expressions that will be used throughout this disclosure. The terms “control unit” or “controlling” are used in the description in a generic sense and should not be limited to open-loop control but rather may also cover term such as “regulation” and “regulating”, i.e. closed-loop control in which a variable to be controlled is continuously monitored (for a position measurement, for example), compared with another variable (i.e. command variable) and, depending on the outcome of this comparison is adapted to the command vehicle. In addition, combinations of open-loop control and closed-loop control, like for example a programmed swivel motion of the outrigger and a (hand-) controlled length movement of the camera are to be understood as well. The term “vehicle” relates to any means of transportation on land, water and air, such as an automobile, in particular a passenger car, truck or motorcycle. The term “camera” may include a photo camera and/or film camera.

The control commands of the movement plan can be stored in the control unit before operating the vehicle. The control unit may hereby have an additional memory. As an alternative, the control signals may also be transmitted via a remote control. In this case, the control unit has an additional receiver for receiving the remote control signal. Through the remote-controlled utilization of the control commands, a user is able to modify the previously set movement plan during operation, as required. During travel of the vehicle, the apparatus may also be operated solely by the remote control signals absent any previously set movement plan.

According to another feature of the present invention, the cross section of at least the outrigger may have a triangular or tetragonal configuration. As a consequence of such a cross section, in particular in conjunction with great side distances and thin wall strength, an outrigger can be realized that is especially stiff and has little weight. Of course, it is also possible to use a round, oval, or a cross section with more than four corners.

According to another feature of the present invention, the mounting element may be detachably arranged on the outrigger and may be secured to at least two of the side surfaces of the outrigger. In this way, the camera viewpoint in relation to the target can be further adjusted to the requirements at hand. Suitably, a portion of the mounting device or the outrigger, in particular the one closest of the vehicle, is made of transparent material. This allows shots of the entire vehicle without any part of the camera rig being visible on the shots that would have to be retouched away subsequently.

According to another feature of the present invention, the outrigger may be made of a fiber composite material, such as carbon fiber reinforced plastic, glass fiber reinforced plastic, and/or aluminum, or of another light metal, like for example titanium, to provide the outrigger of slightest possible weight. Any material combinations of the afore-mentioned or other materials are possible.

According to another feature of the present invention, the outrigger may be constructed to have a joint. By means of the this joint, the outrigger can be bent such as to allow the camera to be held in further spatial dispositions relative to the portion of the outrigger that is connected to the swivel mechanism. Preferably, also the joint of the outrigger may be part of a separate swivel mechanism.

According to another aspect of the present invention, a camera rig system includes a vehicle, at least one camera, and an apparatus for securing the camera to the vehicle, including an outrigger, a mounting device for connecting the outrigger to the vehicle, a mounting element disposed at the outrigger for fastening a camera, preferably at a vehicle-distal area of the outrigger, and a swivel mechanism for controlled pivoting of the outrigger, wherein the mounting device is secured to the underside of the vehicle.

Fields of application that are especially preferred for the apparatus according to the invention and a camera rig system according to the invention are photographic images and moving images of vehicles, when the apparatus according to the invention is mounted upon the vehicle that is to be shot. In this way, the system according to the invention and a respective use of the apparatus according to the invention differs from applications in which a camera is mounted on a first vehicle to take an image of a second vehicle. This preferred field of application in particular sets stringent standards because the image must be substantially free of reflections from the apparatus or the camera on the typically varnished surface, which would require retouching in subsequent image processing operations. In addition, components of the apparatus must not be visible on the image. Finally, even under consideration of the afore-mentioned limits, the attachment of the apparatus on the vehicle being shot has to meet the high demands as far as attenuation of vibrations is concerned so that sharp shots can be taken of the vehicle.

In accordance with the present invention, the mounting device can thus be pushed underneath the vehicle, and the apparatus can be connected to the vehicle from below via the mounting device. According to another feature of the present invention, the mounting device alone or the joint and the mounting device together is hereby suited to a particularly shallow structural height of maximal 300 mm, preferably maximal 270 mm, for the mounting device and the joint connected to the mounting device.

According to another feature of the present invention, the mounting device may have an elongate base carrier having one end for arrangement of the joint. This construction has been proven especially advantageous for introducing the forces and moments, applied by the outrigger on the joint (that may be part of the swivel mechanism) connecting the outrigger to the mounting device, into the vehicle supporting the apparatus. In particular, as the length of the base carrier increases, the moments that rise with increasing length of the outrigger can be effectively absorbed.

The base carrier, in cross section perpendicular to the length axis, can have a width which is greater than a height. This rectangular cross section is, as such, already especially torsion-resistant. By selecting a slight height, the structural height of the mounting device can be reduced in an especially effective manner so that the apparatus according to the invention can be used even for low vehicles. In particular preferred is a height of the base carrier of maximal 100 mm, preferably maximal 80 mm.

According to another feature of the present invention, the center plane of the base carrier is disposed underneath the center plane of the joint, with an angle piece connecting the base carrier to the joint. This arrangement allows for example to design only the base carrier especially shallow, when the joint is arranged in front of, next to, or behind the vehicle, and to utilize the available free space outside the vehicle for the joint. The elevated position of the joint in particular allows a better protection of the sensitive parts of the swivel drive for the outrigger, when the latter is based on components of the joint. Impacts caused when the joint hits the roadway are reduced in particular. Furthermore, the elevated disposition of the joint enables the arrangement of parts of a swivel drive, for example hydraulic cylinders, underneath the joint, while their ends do not project beyond the plane of the underside of the base carrier. Arranging these parts underneath the joint decreases the risk that these components become visible in the shot being taken.

On its end opposite to the joint, the base carrier may have an option for attachment of the base carrier to the vehicle. In addition, or as an alternative, a mounting rail for a connection element may be provided on at least one length side of the base carrier, with the connection element being configured such that it can be shifted along the mounting rail and fixed at a desired position. The connection element is intended to connect the base carrier to the vehicle. As a result of the mobility of the connection element in relation to the base carrier, it is possible, for example when the base carrier is aligned in a predefined way in relation to the vehicle, to move the connection element to a location where an attachment to the vehicle is especially good, or to a location where the greatest moments and forces can be introduced into the vehicle, for example by adjusting an especially great lever arm.

The connection element may be made of two parts. For example, the connection element may have a first arm which is connected to the mounting rail and is connected to a second arm which is disposed at an angle to the first arm, wherein the second arm has a joint. This arrangement enhances the versatility of alignments of the connection element so as to be able to best suit the conditions at hand while still holding the base carrier in a desired position. In particular preferred is the provision of a mounting rail for the second arm on at least one length side of the first arm, with the second arm being configured such as to be able to move along the mounting rail and to be fixed at a desired position.

According to another feature of the present invention, the base carrier may be constructed telescopically along its length axis. This allows, for example when a connection element is provided on the end of the base carrier for connecting the base carrier to the vehicle, to shift this connection element in relation to the base carrier and thereby suit it to the situations of the vehicle.

The connection element may include a ball-and-socket joint with a restraining arm provided on the ball. For example, when the connection element is of multipart construction, the ball-and-socket joint can be provided between the first and the second arm. Suitably, the ball socket of the joint for movement in relation to a first arm on this first arm, and the second arm includes on its one end the ball held in the ball socket.

According to yet another aspect of the present invention, a carrier system includes the afore-described apparatus, and at least two end pieces which are movable in a base element of the base carrier for implementing the telescoping capability of the base carrier while being fixable in place relative to the base element, with a first end piece being configured rectilinear, and a second end piece defining an angle between an end insertable into the base element and an opposite end. Such a carrier system takes for example into account that the base carrier must be arranged in a first position, for example to prevent a collision with the spring paths of the springs of the vehicle's chassis, so that a rectilinear end of the telescoping base carrier does not offer in this position a suitable mounting possibility to the vehicle. In such a case, an angled end provides advantages. As the actual installation position of the base carrier is oftentimes unknown when planning the shot, it is recommended to combine several end pieces of the telescoping base carrier in a carrier system so that a decision can be made on-site which end piece is actually to be used.

According to another feature of the present invention, the mounting device may be constructed substantially V-shaped and connected to the automobile by three points of articulation. Suitably, the mounting device is secured in the forward or rearward area of the automobile such that at least the apex of the V-shaped mounting device is secured in the area of the forward or rearward crash box and the ends of the two legs of the V-shaped mounting device are secured respectively in the area of a side sill or longitudinal beam of the automobile. In this way, an advantageous distribution of the reactive forces can be realized across massively designed parts of an automobile.

The camera rig system according to the present invention may further include a control unit for a drive of the vehicle by which the drive and in particular the mounting device of the vehicle can be controlled. Suitably, the vehicle has displacement pickups for this purpose. According to another feature of the present invention, a drive is provided separately to the drives typically installed in vehicles and secured for example to the outside of the vehicle. This may be an electric motor for example.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a perspective illustration of a camera rig system according to the present invention;

FIG. 2 is a schematic bottom view of a mounting device for securing an outrigger of the camera rig system to a vehicle;

FIG. 3 is a schematic fragmentary side view, on an enlarged scale, of the camera rig system;

FIG. 4 is a schematic illustration of a control system for the camera rig system;

FIG. 5 is a schematic frontal view of a variation of a camera rig system according to the present invention;

FIG. 6 is a sectional view of an elongated base carrier, taken along the line A-A in FIG. 2,

FIG. 7 is a schematic fragmentary side view of the camera rig system;

FIG. 8A is a detailed view of an end piece that is moveable in the base carrier for implementing a telescoping capability;

FIG. 8B is a schematic side view of a variation of an end piece; and

FIG. 9 is a detailed view of a modification of the mounting device of FIG. 2.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

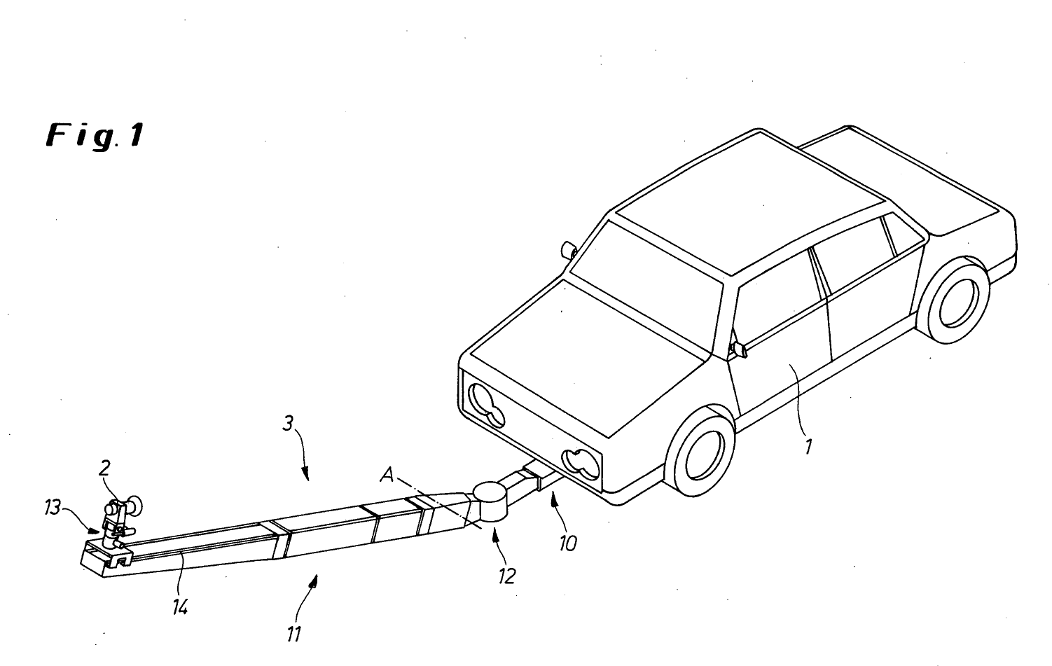

Turning now to the drawing, and in particular to FIG. 1, there is shown a perspective illustration of a camera rig system according to the present invention, generally designated by reference numeral 3, for securing a film camera 2 to a vehicle 1. The camera rig system 3 includes an outrigger 11, a mounting device 10 for securing the outrigger 11 to the vehicle 1, and a joint 12 which is disposed between the mounting device 10 and the outrigger 11 and forms part of a swivel mechanism by which the outrigger 11 can be pivotally controlled about a vertical axis of the joint 12. Further provided at a camera-proximal end of the outrigger 11 is a mounting element 13 for securing the camera 2. Provided on the camera-proximal end of the outrigger 11 are guide rails 14 by which the mounting element 13 for the camera 2 can be guided along the outrigger 11. The camera rig system further includes a lifting unit which forms another part of the swivel mechanism and pivots the outrigger 11 about a horizontal axis A, as will be described in more detail with reference to FIG. 3.

By means of the camera rig system 3, moving images of the vehicle can be taken during travel. As a consequence of the controlled pivoting of the outrigger 11 and the mobility of the camera 2 along the outrigger 11, the relative position and the relative movement of the camera 2 with respect to the vehicle 1 can be modified. In this way, when the camera 2 records a moving image at constant travel speed, it is still possible to record acceleration effects, or—if provided by the screenplay for example—to execute a camera movement towards persons in the vehicle and at the same time to modify hereby the viewing angle. In contrast to prior art systems with a camera which stays during shooting always at the same relative position and relative speed (that is no relative speed) to the vehicle, the camera rig system according to the invention with the apparatus allows a significantly more flexible use of the camera rig.

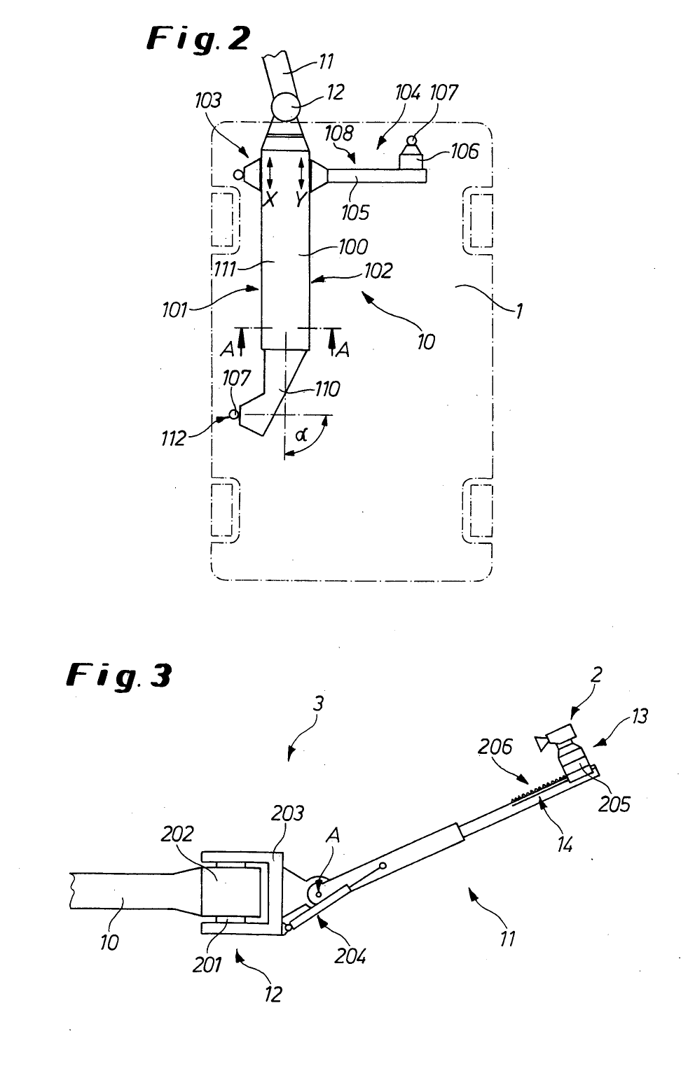

FIG. 2 shows the attachment of the camera rig system 3 to the underside of the vehicle 1 by means of the mounting device 10. The mounting device 10 includes an elongate base carrier 100 which has one end for arrangement of the joint 12. Provided on both length sides 101, 102 of the base carrier are mounting rails 701 (FIG. 9) which guide two connection elements 103, 104, respectively, for movement in the direction of arrows X, Y. Once the connection elements 103, 104 reach a desired position, they can be fixed in place. The connection element 104 has a first arm 105 which is connected to the mounting rail 701 and is connected to a second arm 106 disposed at an angle in relation to the first arm 105, with the second arm 106 including a joint, namely a ball-and-socket joint 107. A mounting rail 703 (FIG. 9) for the second arm 106 is provided on a length side 108 of the first arm 105, with the second arm 106 being configured such as to be movable along the mounting rail 703 and fixable at a desired position.

The base carrier 100 is constructed telescopically along its longitudinal axis and includes an end piece 110, which is displaceable in a base element 111 (FIG. 7) of the base carrier 100 for implementing the telescopic capability of the base carrier 100 but is fixable in place in relation to the base element 111, whereby the end piece 110 defines an angle α between the end insertable into the base element 111 and the opposite end. A connection element 112 is provided on the base carrier 100 at the end opposite to the joint 12 for connecting the base carrier 100 to a longitudinal beam of the vehicle. The connection element 112 includes a ball-and-socket joint 107 with a restraining arm provided on the ball.

As can be seen from FIG. 3, the joint 12 connecting the mounting device 10 and the outrigger 11 forms the part of the swivel mechanism that allows for swiveling around the vertical axis of the joint 12. The joint 12 includes a rotor 201 and a stator 202 of an electric motor. The stator 202 is carried by the mounting device 10. The rotor 201 is attached to the outrigger 11 by means of a holding bracket 203. The lifting unit of the swivel mechanism for moving the outrigger 11 about the horizontal axis A is also attached to the holding bracket 203 and includes a hydraulic cylinder 204. One end of the hydraulic cylinder 204 is hereby connected to the outrigger 11, whereas the other end of the hydraulic cylinder 204 is connected to the holding bracket 203.

FIG. 3 further shows the guide rails 14 by which the mounting element 13 for the camera 2 can be guided along the outrigger 11. A drive 205 has a pinion (not shown) that allows the drive to move the mounting element 13 along a toothed path 206 in a rack and pinion-fashion.

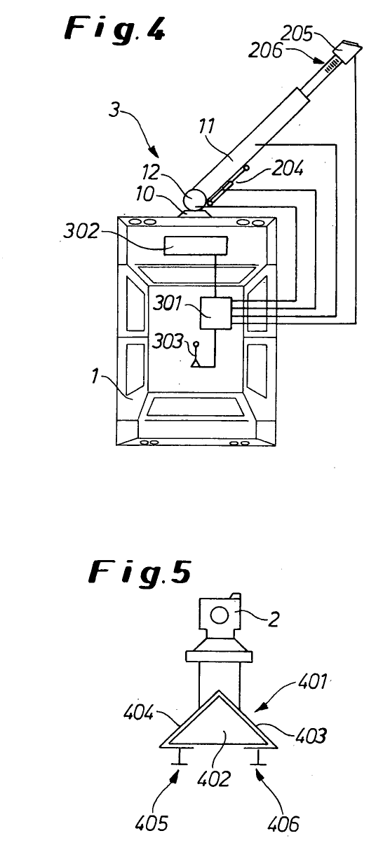

Referring now to FIG. 4, there is shown a schematic illustration of a control system for operating the camera rig system. The control system includes a controller 301 which controls operation of the swivel mechanism and the drive 205 of the mounting element 13. The controller 301 is programmable and operatively connected to the electric motor with rotor 201 and stator 202. In addition, the controller 301 is operatively connected to the hydraulic cylinder 204 and to a telescopic drive (not shown), fitted inside the outrigger 11 for implementing a telescopic movement of the outrigger 11. The controller 301 also has a connection to the motor 302 of the vehicle 1 and is provided with an antenna 303 for receiving a remote control signal generated by a user for initiate a desired movement of the camera rig system 3.

Turning now to FIG. 5, there is shown a schematic frontal view of a variation of a camera rig system according to the present invention. The description below will center on the differences between the embodiments. In this embodiment, provision is made for an outrigger 402 of triangular configuration and a different type of mounting element 401 for attaching the camera 2 to the outrigger 402. The mounting element 401 has brackets 403 and 404 which respectively extend in parallel relationship to opposite sides of the triangular outrigger 402 and are configured for attachment to at least two sides surfaces of the triangular outrigger 402. Fixing screws 405, 406 allow the mounting element 401 to be attached to the outrigger 402 at a desired position.

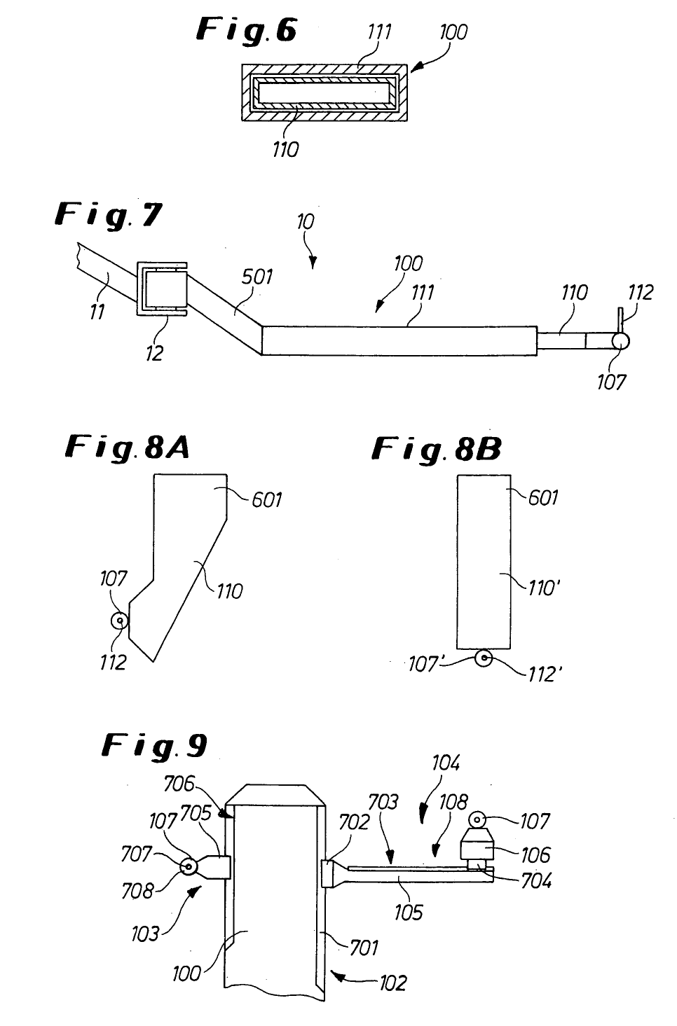

As described above and shown in greater detail in FIG. 6, the base carrier 100 is constructed telescopically along its longitudinal axis by means of the end piece 110, which is displaceable in the base element 111 of the base carrier 100. As shown in particular in FIG. 6, the base carrier 100 has a width which is greater than its height in a cross section perpendicular to the length axis.

As can be seen from FIG. 7, the center plane of the base carrier 100 of the mounting device 10 is arranged below the center plane of the joint 12. An angle piece 501 connects the base carrier 100 with the joint 12.

FIG. 8A shows the end piece 110 which is configured to define the angle α between an end 601 that is insertable into the base element 111 and an end that carries the ball-and-socket joint 107. FIG. 8B shows a variation of an end piece 110′ which is configured rectilinear, with the end that carries the ball-and-socket joint 107′ extending in alignment with the end 601′ that is insertable into the base element.

As described above and shown in FIG. 9, the mounting rail 701 for guiding the connection element 104 is mounted along one length side 102 of the base carrier 100. The connection element 104 has a bracket 702 that grips into the mounting rail 701, with the first arm 105 of the connection element 104 connected to the mounting rail 701. The second arm 106 of the connection element 104 is disposed at an angle to the first arm 105, with the joint 107 on the second arm 106 holding a further arm which extends at an angle to the plane of the first arm 105 and the second arm 106. The mounting rail 703 for the second arm 106 is provided on one length side of the first arm 105 and allows a movement of the second arm 106 along the mounting rail 703, with the second arm 106 provided with a bracket 704 for gripping into the mounting rail 703.

The connection element 103 of the mounting device 10, as shown in FIG. 9, has a slightly different configuration compared to the configuration of FIG. 2, and is made of two parts only. The connection element 103 has a first arm 705 which is attached to a mounting rail 706 and is connected to a second arm 707, of which only the cross-section is visible in the view of FIG. 9, as the second arm 707 is disposed at an angle to the plane of the first arm 705. The first arm 705 supports a ball socket 708 of the ball-and-socket joint 107 which allows a movement of the second arm 707 in relation to the first arm 705. In this multipart construction of the connection element 103, the ball-and-socket joint 107 is provided between the first arm 705 and the second arm 707, with the ball socket 708 of the joint 107 arranged on this first arm, and the second arm 707 supporting on one end the ball held in the ball socket 708.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. Apparatus for attachment of a camera to a vehicle, comprising:
an outrigger;
a mounting device for securing the outrigger to the vehicle;
a mounting element at the outrigger for fastening a camera; and
a swivel mechanism for controlled pivoting of the outrigger.

2. The apparatus of claim 1, wherein the swivel mechanism is constructed to pivot the outrigger about at least two axes.

3. The apparatus of claim 2, wherein the swivel mechanism is constructed to pivot the outrigger about a substantially vertical axis.

4. The apparatus of claim 1, wherein the swivel mechanism includes a lifting unit for pivoting the outrigger about a substantially horizontal axis.

5. The apparatus of claim 1, wherein the mounting element is movably connected to the outrigger so as to be moveable on or in the outrigger in length direction thereof.

6. The apparatus of claim 5, further comprising a drive for controlled movement of the mounting element on or in the outrigger.

7. The apparatus of claim 6, further comprising a control unit for controlling operation of at least one of the swivel mechanism and the drive of the mounting element.

8. The apparatus of claim 7, wherein the control unit has a programmable controller.

9. The apparatus of claim 7, wherein the control unit has a receiver for receiving a remote control signal generated by a user for manipulating a movement of the outrigger.

10. The apparatus of claim 1, wherein the outrigger has a triangular cross section.

11. The apparatus of claim 1, wherein the outrigger has a tetragonal cross section.

12. The apparatus of claim 1, wherein the mounting element is detachably mounted to at least two side surfaces of the outrigger.

13. The apparatus of claim 1, wherein the mounting device has a portion of transparent material.

14. The apparatus of claim 1, wherein the outrigger is made of a fiber composite material.

15. The apparatus of claim 1, wherein the swivel mechanism has a joint, disposed between the mounting device and the outrigger, for allowing a rotation of the outrigger about a vertical axis of the joint, said mounting device and said joint defining together a height of maximal 300 mm.

16. The apparatus of claim 1, wherein the swivel mechanism has a joint, disposed between the mounting device and the outrigger, for allowing a rotation of the outrigger about a vertical axis of the joint, said mounting device and said joint defining together a height of maximal 270 mm.

17. The apparatus of claim 1, wherein the swivel mechanism has a joint, connected to the mounting device, for allowing a rotation of the outrigger about a vertical axis of the joint, said mounting device having an elongate base carrier having one end for arrangement of the joint.

18. The apparatus of claim 17, wherein the base carrier in a cross section perpendicular to the length axis has a width which is greater than a height.

19. The apparatus of claim 17, wherein the base carrier has a height of maximal 100 mm.

20. The apparatus of claim 17, wherein the base carrier has a height of maximal 80 mm.

21. The apparatus of claim 17, wherein the base carrier is defined by a center plane which is arranged below a center plane of the joint, and further comprising an angle piece connecting the base carrier with the joint.

22. The apparatus of claim 17, further comprising a first mounting rail provided at least on one length side of the base carrier, and a first connection element attached to the mounting rail for movement along the mounting rail and constructed for fixation at a desired position along the mounting rail.

23. The apparatus of claim 22, wherein the connection element has a first arm which is connected to the mounting rail and a second arm connected to the first arm at an angle thereto, said second arm having a joint.

24. The apparatus of claim 23, further comprising a second mounting rail provided on at least one length side of the first arm, said second arm connected to the second mounting rail for movement along the mounting rail and constructed for fixation at a desired position along the second mounting rail.

25. The apparatus of claim 17, wherein the base carrier is constructed telescopically along its length axis.

26. The apparatus of claim 22, further comprising a second connection element provided at a joint-distal end of the base carrier for connecting the base carrier to another component.

27. The apparatus of claim 26, wherein each of the first and second connection elements includes a ball-and-socket joint with a restraining arm provided on a ball of the ball-and-socket joint.

28. A carrier system, comprising an apparatus according to claim 25; and at least two end pieces which are movable in a base element of the base carrier for implementing the telescoping capability of the base carrier while being fixable in place relative to the base element, with a first end piece being configured rectilinear, and a second end piece defining an angle between an end insertable into the base element and an opposite end.

29. A camera rig system, comprising:
a vehicle;
at least one camera; and
an apparatus according to claim 1 for securing the camera to the vehicle, wherein the mounting device is secured to the underside of the vehicle.

30. The system of claim 29, wherein the swivel mechanism has a joint, connected to the mounting device, for allowing a rotation of the outrigger about a vertical axis of the joint, said mounting device having an elongate base carrier having one end for arrangement of the joint and arranged predominantly underneath the vehicle.

31. The system of claim 30, wherein the mounting device is connected to the vehicle such that the joint is arranged next to, in front of, or behind the vehicle.

32. The system of claim 29, wherein the vehicle is an automobile.

33. The system of claim 29, wherein the mounting device is constructed substantially V-shaped and connected to the automobile by three points of articulation.

34. The system of claim 29, wherein the camera is a photo camera and/or film camera.
